(19) United States
(12) Patent Application Publication
(10) Pub. No.: US 2015/0032728 A1
(43) Pub. Date: Jan. 29, 2015

(54) SYSTEM AND METHOD OF GENERATING A SET OF SEARCH RESULTS

(71) Applicants: Ryan Rozich, Austin, TX (US); Roji John, Austin, TX (US); Tyron Jerrod Stading, Austin, TX (US)

(72) Inventors: Ryan Rozich, Austin, TX (US); Roji John, Austin, TX (US); Tyron Jerrod Stading, Austin, TX (US)

(21) Appl. No.: 14/316,305

(22) Filed: Jun. 26, 2014

Related U.S. Application Data
(63) Continuation of application No. 12/112,537, filed on Apr. 30, 2008, now abandoned.
Application No. 12/112,537 is a continuation-in-part of application No. 11/731,377, filed on Mar. 30, 2007.

(51) Int. Cl. G06F 17/30; G06F 3/0484; G06F 17/22

(52) U.S. Cl. CPC G06F 17/30011; G06F 17/30867; G06F 17/2235; G06F 3/0484
USPC 707/722

(57) ABSTRACT

In a particular embodiment, a system includes an interface responsive to a network to receive data related to a first document and includes processing logic and memory accessible to the processing logic. The memory stores a plurality of modules executable by the processing logic to recursively retrieve documents, extract directed links and attributes, and traverse the directed links to identify a first set of search results. The plurality of modules includes a search module to retrieve one or more documents and includes an attribute extraction module to extract directed links and other attributes from the one or more documents. The plurality of modules further includes a backward/forward link traversal module to bi-directionally traverse directed links to identify documents and includes a graphical user interface (GUI) module to generate a GUI including data related to the first set of search results and to provide the GUI to a destination device via the network.

### CROSS-REFERENCE TO RELATED APPLICATION

The present application is continuation of and claims priority to U.S. patent application Ser. No. 12/112,537 filed on Apr. 30, 2008 and entitled “System and Method of Generating a Set of Search Results,” which is a continuation-in-part of and claims priority from U.S. patent application Ser. No. 11/731,377, filed on Mar. 30, 2007, and entitled “SYSTEM AND METHOD OF GOAL-ORIENTED SEARCHING,” the content of which is hereby incorporated by reference in its entirety.

### FIELD OF THE DISCLOSURE

The present disclosure is generally related to a system and method of generating a set of search results. More particularly, the present disclosure relates to a system and method of generating the set of search results by bi-directionally traversing associations between documents within a document space.

### BACKGROUND

In general, public information sources, such as the Internet, present challenges for information retrieval. The volume of information available via the Internet grows daily, and search engine technologies have scaled dramatically to keep up with such growth. Conventionally, search engines, such as those provided by Yahoo, Google, and others, utilize data collection technologies, such as spiders, bots, and web crawlers, which are software applications that access web pages and trace hypertext links in order to generate an index of web page information. The data collected by such software applications is typically stored as pre-processed data on which search engines may operate to perform searches and to retrieve information.

Additionally, a vast amount of data exists that is not accessible to the public Internet (e.g., “dark web” data, internal data, internal application data, private data, subscription database data, other data sources, or any combination thereof). Such data can often be searched via private access interfaces, private search tools, other application program interfaces, or any combination thereof. Such information may be segregated from other information sources, requiring multiple interfaces, multiple protocols, multiple formats, and different database drivers to access the data. Accordingly, information retrieval can be complicated by the variety of data sources.

To improve the quality of search results and to remove “junk results,” search engines may include logic or tools to fine-tune the search results. In some instances, such fine-tuning may be based on relevance to other users, on a number of links from other web pages to a particular resource, or on a combination of information that is not specific to a user's interests (i.e. the user's search and the question related to the user's search). Additionally, with the volume of search results, even after fine-tuning, it often remains difficult to identify desired information.

### SUMMARY

In a particular embodiment, a system includes an interface responsive to a network to receive data related to a first document and including processing logic and memory accessible to the processing logic. The memory stores a plurality of modules executable by the processing logic to recursively retrieve documents, extract directed links and attributes, and traverse the directed links to identify a first set of search results. The plurality of modules includes a search module to retrieve one or more documents and includes an attribute extraction module to extract directed links and other attributes from the one or more documents. The plurality of modules further includes a backward/forward link traversal module to bi-directionally traverse directed links to identify documents and includes a graphical user interface (GUI) module to generate a GUI including data related to the first set of search results and to provide the GUI to a destination device via the network.

In another particular embodiment, a method of generating a set of search results is disclosed that includes identifying one or more associations between a first document and a first set of search results and recursively traversing the one or more associations bi-directionally to retrieve a second set of search results based on associations to the first set of search results. Each search result of the second set of search results including multiple data variables. The method further includes selectively pivoting on a particular data variable from the multiple data variables of at least one result of the second set of search results to generate a third set of search results and sending a graphical user interface (GUI) including data related to the third set of search results to a destination device via a network.

In still another particular embodiment, a method of generating a set of search results is disclosed that includes recursively traversing directed links from a first document of a document space to one or more documents in the document space and from the one or more documents to other documents in the document space to find backward related documents associated with the first document. The method further includes concurrently searching the document space recursively by using an identifier related to the first document to identify related documents that include an association to the first document and using identifiers from the related documents to identify forward related documents. The method also includes generating a graphical user interface (GUI) including a plurality of selectable indicators corresponding to the backward and forward related documents and includes providing the GUI to a destination device.

### BRIEF DESCRIPTION OF THE DRAWINGS

FIG. 1 is a block diagram of a particular illustrative embodiment of a search system to generate a set of search results;

FIG. 2 is a block diagram of a particular illustrative embodiment of a set of search results illustrating bi-directional traversal of associations between documents of a document space;

FIG. 3 is a block diagram of a third particular illustrative embodiment of a system to generate a set of search results;

FIG. 4 is a block diagram of a second particular illustrative embodiment of a set of search results illustrating bi-directional traversal of associations between documents and illustrating pivoting on an attribute;

FIG. 5 is a block diagram of a particular illustrative embodiment of method of generating a set of search results illustrating multi-variable searching and bi-directional traversal of associations between documents;

FIG. 6 is a block diagram of a fourth particular illustrative embodiment of a set of search results illustrating multi-variable searching and bi-directional traversal of associations between documents;

FIG. 7 is a flow diagram of a particular illustrative embodiment of a method of generating a set of search results;

FIG. 8 is a flow diagram of a second particular illustrative embodiment of a method of generating a set of search results;

FIG. 9 is a flow diagram of a third particular illustrative embodiment of a method of generating a set of search results;

FIG. 10 is a flow diagram of a fourth particular illustrative embodiment of a method of generating a set of search results;

FIG. 11 is a diagram of a particular illustrative embodiment of a graphical user interface (GUI) to generate a set of search results using structured or unstructured searches;

FIG. 12 is a diagram of a second particular illustrative embodiment of a GUI to generate a set of search results using unstructured or partially structured searches;

FIG. 13 is a diagram of a particular illustrative embodiment of a GUI including user selectable indicators related to a list of search results; and

FIG. 14 is a diagram of a second particular illustrative embodiment of a GUI including a visualization of the set of search results.

### DETAILED DESCRIPTION OF ILLUSTRATIVE EMBODIMENTS

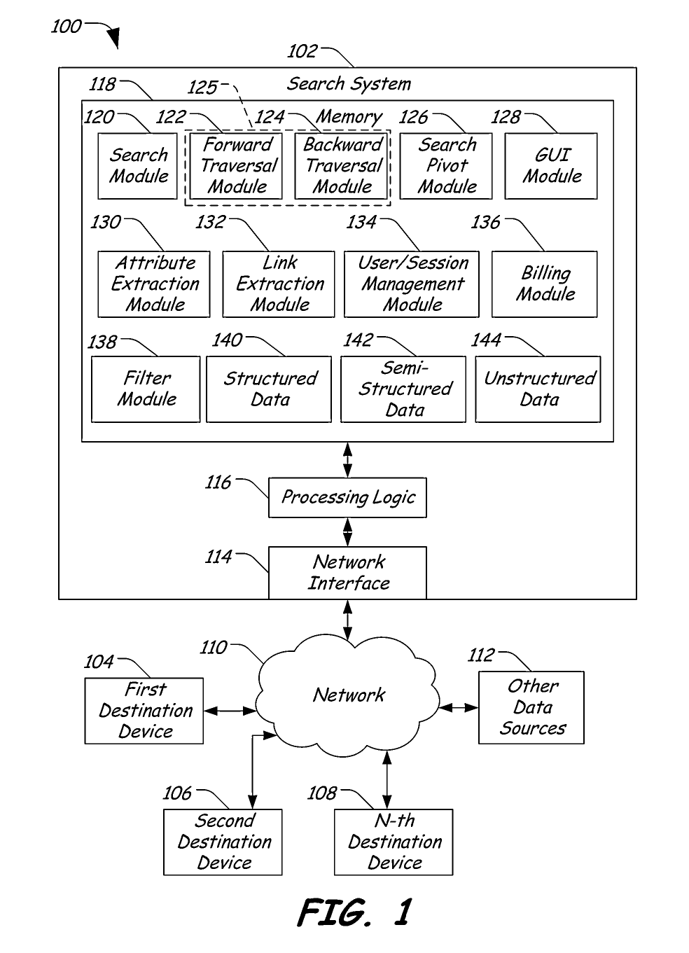

FIG. 1 is a block diagram of a particular illustrative embodiment of a search system 100 to generate a set of search results. The system 100 includes a search system 102 that communicates with a first destination device 104, a second destination device 106, and an N-th destination device 108 via a network 110. In a particular embodiment, the network 110 can be a local area network or a wide area network. In a particular example, the network 110 is an embodiment of the world-wide-web (i.e., the Internet). The search system 102 also communicates with one or more data sources 112 via the network 110. The one or more data sources 112 can include unstructured data, semi-structured data, structured data, or any combination thereof. In general, semi-structured data includes tagged data, such as hypertext documents, extensible markup language (XML) documents, or other documents that include defined data structures. Unstructured data includes free-text documents. Structured data includes database-type data structures.

The search system 102 includes a network interface 114 that is responsive to the network 110. The search system 102 also includes processing logic 116 coupled to the network interface 114 and includes a memory 118 that is accessible to the processing logic 116. In a particular embodiment, the search system 102 can be a single computing device. In another particular embodiment, the search system 102 can be distributed across a plurality of servers, such that the processing logic 116 and the memory 118 are distributed among multiple computing devices that may communicate via the network 110 to provide search and retrieval functionality. In general, the selected attribute may be described as a document dimension, and the search may be referred to as a multi-variate, multi-dimensional search.

The memory 118 stores a plurality of modules that are executable by the processing logic 116. The memory 118 includes a search module 120 that is executable by the processing logic 116 to search a document space (i.e., one or more data sources). The document space can include multiple search engines and multiple data sources. In a particular embodiment, the search module 120 includes a query proxy feature adapted to proxy a query to match search logic associated with a particular search engine (such as the Google search engine) or database, to match search logic associated with a particular data source, or any combination thereof.

The memory 118 also includes a forward traversal module 122 and a backward traversal module 124 that are executable by the processing logic 116 to traverse associations between documents of the document space. In a particular embodiment, the forward and backward traversal modules 122 and 124 can be combined into a single module, such as a backward/forward link traversal module 125. In general, an association refers to an attribute that relates two documents. For example, a citation contained in a first document may be referred to as a directed link or a backward association from the document to another related document. In a particular example, a directed link can be a hypertext link to a related document. The backward traversal module 124 can be used to traverse such directed links to identify backward associated documents. In some instances, it can be more difficult to identify forward related documents. A forward related document refers to a document that includes citation or directed link to the first document. In patents, for example, a forward related document may be another patent application or issued patent that cites a first patent as a prior art reference. In the patent database at the United States Patent Office, a “referenced by” link is provided to retrieve forward related documents. In this instance, the forward traversal module 122 is adapted to traverse the “referenced by” directed link to identify a set of forward related documents. In another particular embodiment, such “referenced by” links may not be available, so the forward traversal module 122 is adapted to search the document space based on an attribute derived from the first document. The attribute may be a title, a unique document identifier (such as a serial number), another attribute, or any combination thereof. To facilitate the forward/backward traversal, the memory 118 includes an attribute extraction module 130 and a link extraction module 132 that are executable by the processing logic 116 to extract attributes and directed links, respectively, from found documents

The memory 118 further includes a search pivot module 126 that is executable by the processing logic 116 to pivot on a selected attribute from a set of search results to perform a search related to the selected attribute. For example, within a set of found documents, each document includes multiple attributes, such as title, author, company (assignee), other information, or any combination there. The search pivot module 126 is adapted to pivot on a selected attribute, such as author, to retrieve a tangentially related set of search results that are linked by the pivot attribute (i.e., the author attribute). In a particular embodiment, the pivot search module 126 is executable by the processing logic 116 to pivot on a selected attribute extracted from a particular search result and to search the document space using the extracted attribute to determine a set of pivot search results.

Additionally, the memory 118 includes a graphical user interface (GUI) module 128 that is executable by the processing logic 116 to generate a GUI including multiple selectable indicators, including tabs, clickable links, user-selectable graphics elements including chart elements, buttons, and other graphical elements. The generated GUI may also include visualizations, lists, or other representations of data related to the set of search results. The memory 118 also includes a user/session management module 134 that is executable by the processing logic 116 to manage user accounts and to manage user sessions with the search system 102. In a particular example, the user/session management module 134 is adapted to manage security, including authentication and authorization to access the search system 102. The user/session management module 134 is also adapted to permit sharing of search results among different users. For example, in a particular instance, a first user may save and may configure a set of search results to be shared with a second user. In this instance, the user/session management module 134 is adapted to facilitate sharing of the saved search results with the second user. The memory 118 also includes a billing module 136 that is executable by the processing logic 116 to manage user accounts, including billing associated with usage of the search system 102. The memory 118 further includes a filter module 138 that is executable by the processing logic 116 to filter a set of search results according to a selected attribute.

In a particular embodiment, the search system 102 is adapted to receive user input from one or more of the first, second, and N-th destination devices 104, 106 and 108 and to execute the search module 120 to search one or more data sources, including structured data 140, semi-structured data 142, and unstructured data 144 stored at the memory 118 and to search one or more other data sources 112 via the network 110.

In a particular embodiment, the memory 118 stores a plurality of modules that are executable by the processing logic 116 to recursively retrieve documents, extract directed links and attributes, and traverse the directed links to identify a first set of search results. The plurality of modules includes the search module 120 to retrieve one or more documents, the attribute extraction module 130 to extract attributes from the one or more documents. In a particular embodiment, the attribute extraction module 130 may include the link extraction module 132 and may be adapted to extract the attributes and directed links from the one or more documents. The plurality of modules further includes backward/forward traversal module 125 to bi-directionally traverse directed links to identify documents and includes a graphical user interface (GUI) module 128 to generate a GUI including data related to the first set of search results and to provide the GUI to a destination device, such as the first destination device 104, via the network 110.

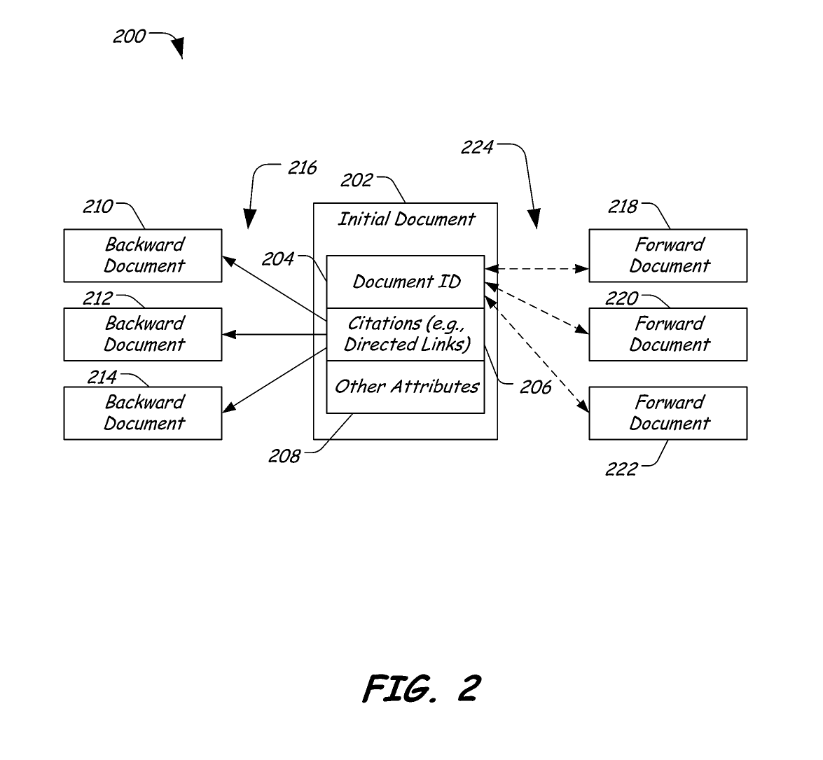

FIG. 2 is a block diagram of a particular illustrative embodiment of a set of search results 200 illustrating bi-directional traversal of associations between documents of a document space. The set of search results 200 includes an initial document 202 that includes a unique document identifier (document ID) 204, one or more citations (e.g., directed links) 206, other attributes 208, or any combination thereof. The other attributes 208 may include author information, document statistics, company data, other information, or any combination thereof. The initial document 202 is related to backward documents 210, 212, and 214 by backward associations 216 that are based on the one or more citations 206. Further, the initial document 202 is related to forward documents 218, 220, and 222 by forward associations 224 based on an attribute of the initial document 202, such as the document ID 204.

In a particular embodiment, a search system, such as the search system 102 illustrated in FIG. 1, is adapted to generate a set of search results by iteratively and recursively extracting attributes and citations from found documents and traversing forward and backward associations 224 and 216 to produce a set of documents. In a patent context, the backward associated documents 210, 212, and 214 may represent prior art references cited in the initial document 202 (i.e., an initial or seed patent), and the forward associated documents 218, 220, and 222 may represent documents that cite the initial document as prior art. In a prior art search context, the search results applied by the patent office during examination may constitute a narrowly tailored set of search results that are closely related to the subject matter content of the initial document 202. Further, by iteratively and recursively traversing document associations, it is possible to retrieve a set of documents that are related to the initial document and then filter those documents that are included in the citations 206 so that the resulting set constitutes uncited references. Further, using a filter module (such as the filter module 138 illustrated in FIG. 1), the set of search results can be filtered to remove documents that are more recent than the initial document 202, such that the resulting set of search results constitutes uncited prior art references. Further, other search filters may be applied to retrieve a different set of search results.

It should be understood that the patent search example is illustrative only, and is not intended to be limiting. The bi-directional link (association) traversal can be implemented on structured data, unstructured data, and semi-structured data, using a combination of automated link traversal and automated attribute searches.

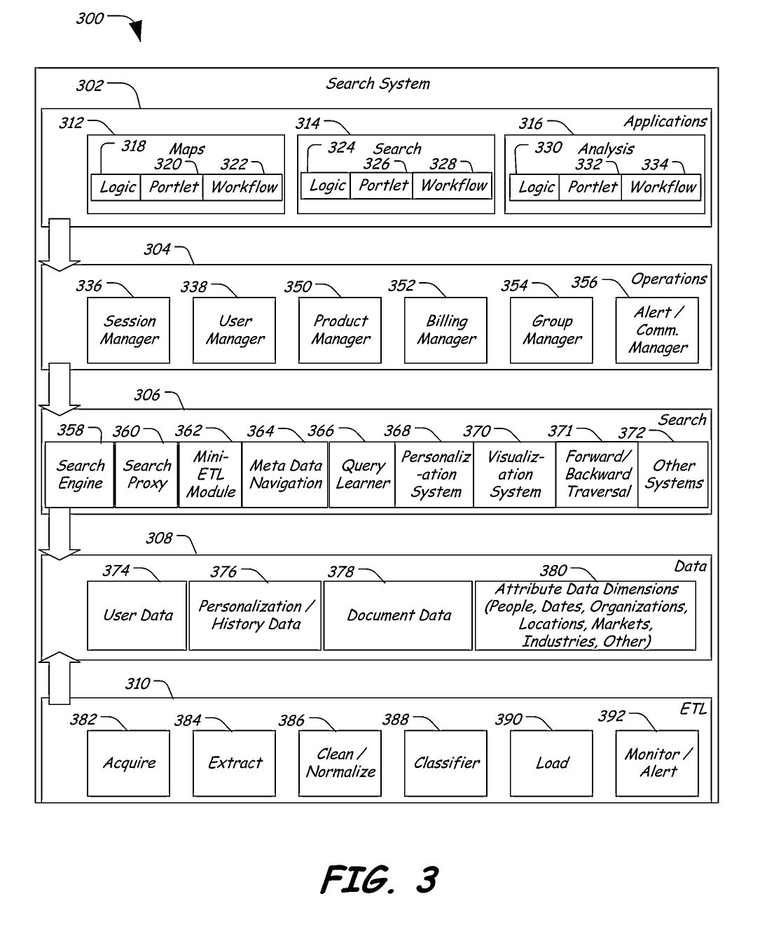

FIG. 3 is a block diagram of a third particular illustrative embodiment of a system 300 to generate a set of search results. The system 300 includes an applications tier 302, an operations tier 304, a search tier 306, a data tier 308, and an extract-transform-load (ETL) tier 310, which include processing logic and instructions executable by the processing logic to search data sources and to present search results.

The applications tier 302 can include multiple applications. Each application can be a combination of logic (display, interaction, etc), portlets (visual components), and workflow (process of how components work together). The applications tier 302 includes a maps module 312 that can be executed by processing logic to visually display landscapes and other visualizations. The applications tier 302 includes a search module 312 that can be executed by processing logic to search multiple data sources, including structured data sources, semi-structured data sources, and unstructured data sources. The applications tier 302 includes an analysis module 312 that can be executed by processing logic to process retrieved data to produce interactive visualizations for analysis.

The maps module 312 can include logic 318 to control the display of information, the graphical user interface for interacting with the information, and other functionality associated with visualizations (maps). The maps module 312 can include a portlet 320 to define visual components for inclusion in a graphical user interface and a workflow module 322 to manage context and flow control. The search module 314 controls a search interface, interactions with data sources, and how searches are performed. The search module 314 can include logic 324 to control the display of search results and to define a graphical user interface for interacting with the search results, a portlet 326 to define visual components associated with a search interface and a workflow module 328 to manage context and flow control. The analysis module 312 includes logic 330 to control the analysis of search results, a portlet 332 to define visual components associated with the analysis (such as a recommend results option). The analysis module 316 includes a workflow module 334 to manage context, flow control, and performance of the analysis.

The operations tier 304 is adapted to manage sessions, to manage user accounts, and to generally manage the user experience. The operations tier 304 can include functionality to provide administrative features, including security features such as authentication and authorization functions. The operations tier 304 can include a session manager 336 to track of user information, user preferences, permissions, and other information. Additionally, the session manager 336 can track user input, implicit and explicit user interactions, store the input and the interactions, and adjust the user experience accordingly, such as by presenting search results in a particular manner to one user and in a different manner to another user. The operations tier 304 also includes a user manager 338 to manage permissions for each user and to manage interconnections. The operations tier 304 includes a product manager 350 to group applications and features for particular subscriptions. The operations tier 304 includes a billing manager 352 to track user activity and to convert user activity to billable events. The operations tier 304 also includes a group manager 354 to track connections between users. For example, the group manager 354 may maintain an address book for each user, a list of associations, and other information, which can be used to facilitate collaboration between users. The operations tier 304 can include an alert/communications manager 356 to communicate with users via email, instant messages, web logs (“blogs”), really simple syndication, documents, simple messaging system text messages, other messages, or any combination thereof, to connect the user to other users and to communicate up-to-date information to a selected user, such as when data is updated, automated search results are received, and so on.

The search tier 306 can include core components and libraries used for the maps module 312, the search module 314 and the analysis module 316 of the applications tier 302. The search tier 306 includes a search engine 358, which can support Boolean searching (i.e. keyword searching uses logical operators, including AND, OR, ANDNOT, and other operators) and which provides filtering and classification (grouping, clustering, other organization, or any combination thereof). The search engine 358 can also support word proximity searches, allowing a user to search for instances of search terms that are separated by less than a user-specified number words (e.g., a first term is within three words of a second term). The search tier 306 also includes a search proxy 360 that provides a search interface to other search engines, to other data sources, or any combination thereof, by generating search queries from Boolean searches to match a desired query format for each data source and to query the data sources on behalf of the user. If Boolean searching is not supported by a particular data source, the search proxy 360 can degrade and translate a Boolean search into another query format, provide a real-time indexing of other search data to allow support for advanced operators, or any combination thereof. In a particular embodiment, advanced operators may include logical operators (AND, OR, NOT, and other operators), range filtering, attribute filtering, proximity searching, other search operations, or any combination thereof. In an embodiment, a user Boolean query with proximity fields could be translated into query that could be sent to the Google search engine. The search module 314 can query the Google search engine using the translated query, receive the search results, optionally download documents associated with the search results, index the resulting documents with advanced searching capabilities to produce a temporary index, and perform the full query on the temporary index.

The search tier 306 includes a reduced extract-transform-load (mini-ETL) module 362 that can be used to parse retrieved documents into temporary tables mapped to an internal format. The search tier 306 also includes a metadata navigation module to extract statistics and patterns from search results, to provide correlations for visual display, and to speed navigation through search results by permitting negation of categories of information, selection of specific information, and user-training of query learner and document learner applications. The search tier 306 includes a query learner module 366 to reverse engineers a user's search into a better query by identifying “good” elements and “bad” elements and by using the identified good and bad elements to generate a modified Boolean query learned from explicit and implicit user interactions. Implicit user interactions can include links followed by a user, length of time spent on a page by the user, commonality of terms between documents associated with links followed by the user, and other implicit information. The explicit user interactions include document ratings supplied by the user for selected items in a list of search results. The search tier 306 includes a personalization system 368 to track each user's input, transaction history, search history, and actions and makes recommendations about documents. The search tier 306 also includes a visualization engine 370 to render internal document data, metadata, and dimensions into various interactive visualizations.

Further, the search tier 306 includes a forward/backward traversal module 371, which is executable by processing logic to bi-directionally traverse associations between documents of a document space. In a particular example, the forward/backward traversal module 371 can be used to traverse associations extracted from a first document to identify one or more documents. In some instances, such associations may be referred to as directed links. The forward/backward traversal module 371 can also be used to identify associated documents in a forward direction based on an attribute extracted from the first document. In a particular example, documents in a forward direction include at least one citation that refers to the first document. Such citations can be directed links from the forward-document back to the first document. The forward/backward traversal module 371 is adapted to operate in conjunction with the mini-ETL module 362 to iteratively and recursively traverse associations between documents in the document space to generate a set of search results, using the backward/forward traversal module 371. The search tier 306 may also include other systems and modules, including algorithms, core libraries to extract patterns, statistics, and otherwise data mine information from documents, and other applications.

The data module 308 can include user data 374, including user preferences, administrative information, and other user account related data. The data module 308 can include personalization/history data that tracks user interactions, explicit feedback, and implicit feedback. The data module 308 includes a document database 378 including multiple tables to store document elements. The data module 308 also includes an attribute database 380 to store information about document attributes, correlations between documents, classifications associated with documents, other information, or any combination thereof.

The ETL tier 310 is adapted to extract information from documents received from any source (local, remote, or any combination thereof) and to convert the information to a “clean” format for internal use. The ETL tier 310 acquires the information using an acquisition module 382, extracts the information using an extraction module 384, and cleans or normalizes the information using a clean/normalize module 386. The ETL tier 310 may also classify search results in “real-time” using a classifier module 388. The classifier module 388 may be trained based on user interactions, based on vertical data sets, or any combination thereof. An example of a vertical data set can be a taxonomy that includes multiple categories or classification. The multiple categories or classifications can have associated documents, which can be utilized to train the classifier module 388 about what types of information are included within a particular category or classification. For example, the United States Patent and Trademark Office classification system is organized hierarchically and each classification includes multiple documents that may be used to train the classifier module 388.

The classifier module 388 performs dynamic correlations between search results, based on metadata, content within particular search results, ownership data, authorship data, data about the data source, and other information. The classifier module 388 may use such dynamic correlations to make probabilistic determinations about missing information, such as assignee information related to a particular patent document. In a particular illustrative, non-limiting example, the classifier module 338 can make a make a probabilistic determination to identify a likely assignee of a patent, even when the records at the United States Patent and Trademark Office do not include assignee information (i.e. the classifier module 388 can guess likely corporate owners for particular patents that appear to be unassigned). While the above-example is provided in the context of patents, the classifier module 388 can be adapted to make probabilistic determinations in a variety of contexts in order to augment search results. Such information may be presented within a graphical user interface in such a way that the probabilistic determinations can be identified as compared to retrieved data. The ETL tier 310 may utilize the load module 390 to store documents, data extracted from the documents, probabilistic determinations, classification data, correlations, and other information related to search results. The ETL tier 310 can use a monitor/alert module to apply user profiles/filters to each document for special alerts. For example, the search system 300 may support publish/subscribe methodologies, such as a really simple syndication technique, to provide updates and notices to users when information of interest to the user is acquired.

In a particular illustrative embodiment, the search system 300 may include a single server. In another particular illustrative embodiment, the search system 300 may include multiple servers having processing logic and memory accessible to the processing logic to provide search and visualization functionality.

In a particular embodiment, the search system 300 may perform a first search based on a Boolean query provided by a user using the search tier 306. The operations tier 304 may coordinate the operation of the applications tier 302 to produce a graphical user interface and to provide the graphical user interface to a destination device associated with the user. The search system 300 may acquire document data using the ETL tier 310 and may assemble information about the user using the data tier 308. The search system 300 may utilize data extracted by the ETL tier 310 to generate a secondary query, which the search tier 306 may use to search one or more data sources to acquire secondary data. The search system 300 may augment the search results with the secondary data. For example, the search system 300 may acquire financial data (secondary data) based on ownership information extracted from the search results (extracted data). The search system 300 may provide the graphical user interface (GUI) to the destination device. The GUI can include the financial data in the form of a visualization, i.e., a visual representation of the search results organized according to a selected dimension, such as an industry visualization, that can be related to the search results. A user may switch between visualizations of the data and search results associated with the data by interacting with user selectable elements of a graphical user interface.

In a particular illustrative embodiment, a system may include a search system 300 that includes a search tier to retrieve search results from multiple data sources and to extract data from the search results. The system may also include a classification system, such as the classifier 388 within the ETL tier 310, to associate each of the search results with at least one classification based on the extracted data. The system can also include a visualization system 370 to generate a graphical user interface (GUI) including data related to the search results and including multiple control options. The multiple control options can include a first option related to the extracted data and a second option related to the at least one classification. Further, a user can interact with the GUI to initiate a pivot search relative to a particular selected attribute (dimension), which search results can be processed using the backward/forward link traversal 371 to produce a set of search results.

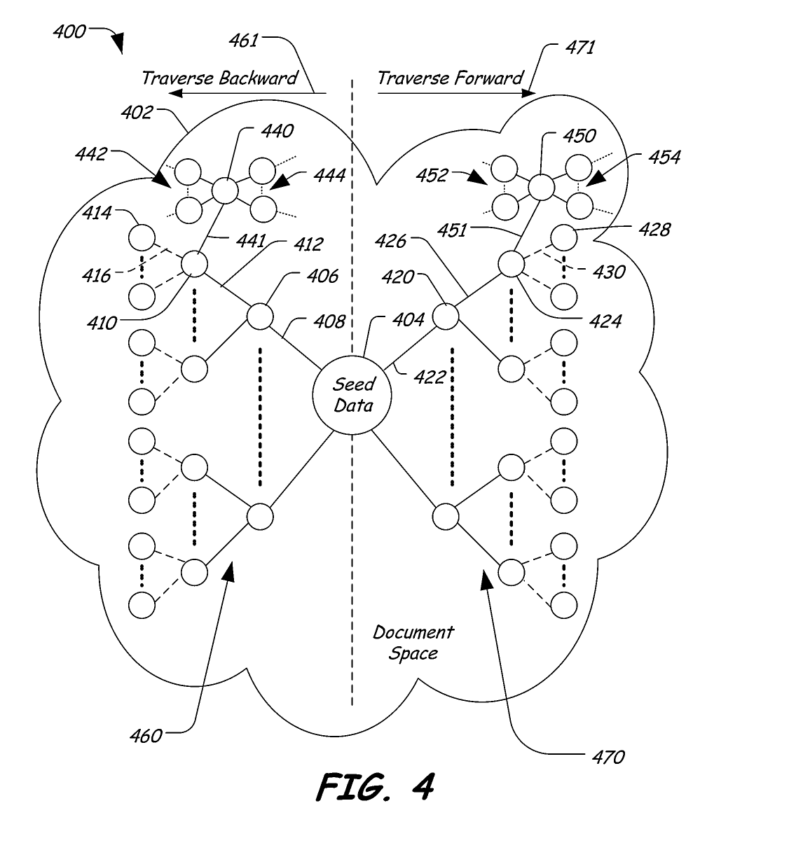

FIG. 4 is a block diagram of a second particular illustrative embodiment of a set of search results 400 illustrating bi-directional traversal of associations between documents and illustrating a pivot search on an attribute. The set of search results 400 is within a document space 402. The set of search results 400 includes a seed data node 404 that is associated with a plurality of backward nodes 460 and a plurality of forward nodes 470. In general, the associations refer to shared attributes, citations, directed links, or any combination thereof, between two document nodes. In a traverse backward direction (generally indicated at 461), the seed data node 404 is associated with a first backward document node 406 by a first backward association 408. The first backward document node 406 is associated with a second backward document node 410 by a second backward association 412. The second backward node 410 is coupled to one or more backward nodes 414 via one or more backward associations 416. Further, the plurality of backward nodes 460 includes a pivot node 440 that is coupled to the second backward node 410 by a first pivot association 441. In general, the first pivot association 441 may be a selected dimension, such as author, company, other attribute data, or any combination thereof, which is tangential to the search results associated with the seed data node 404. The pivot node 440 may be associated with one or more backward nodes 442 and one or more forward nodes 444. In general, it should be understood that the seed data node 404 may be directly associated with a plurality of first data nodes 406, and may be indirectly associated with a plurality of second data nodes, third data nodes, and N-th data nodes. In particular, the search logic is adapted to search the document space 402 recursively, to identify any number of levels (tiers) of backward associations in order to generate a set of backward associated search results.

Additionally, the seed data node 404 is associated with a first forward node 420 via a first forward association 422. The first forward node 420 is associated with a second forward node 424 via a second forward association 426. The second forward node 424 is associated with one or more forward nodes 428 via one or more forward associations 430. Further, the plurality of forward nodes 470 includes a pivot node 450 that is associated with the second forward node 424 via a second pivot association 451. In general, the second pivot association 451 may be a selected dimension, such as author, company, other attribute data, or any combination thereof, which is tangential to the search results associated with the seed data node 404. The pivot node 450 can be associated with one or more backward nodes 452 and one or more forward nodes 454.

In general, the forward and backward traversal described by the set of search results 400 illustrated in FIG. 4 may include multiple document nodes in both the forward and backward traversal directions at each tier (i.e., at each level of association). For example, the first backward node 406 may have multiple sibling nodes. Similarly, the first forward node 420 may have multiple sibling nodes. The search results may be visualized as a node tree, where each node represents a found document and each link represents an association between the found document and a previously found document. The resulting node tree may have any number of nodes and may identify documents having multiple shared associations and multiple shared attributes (dimensions). Further, the node tree may extend to a selected number of levels, which may be user defined.

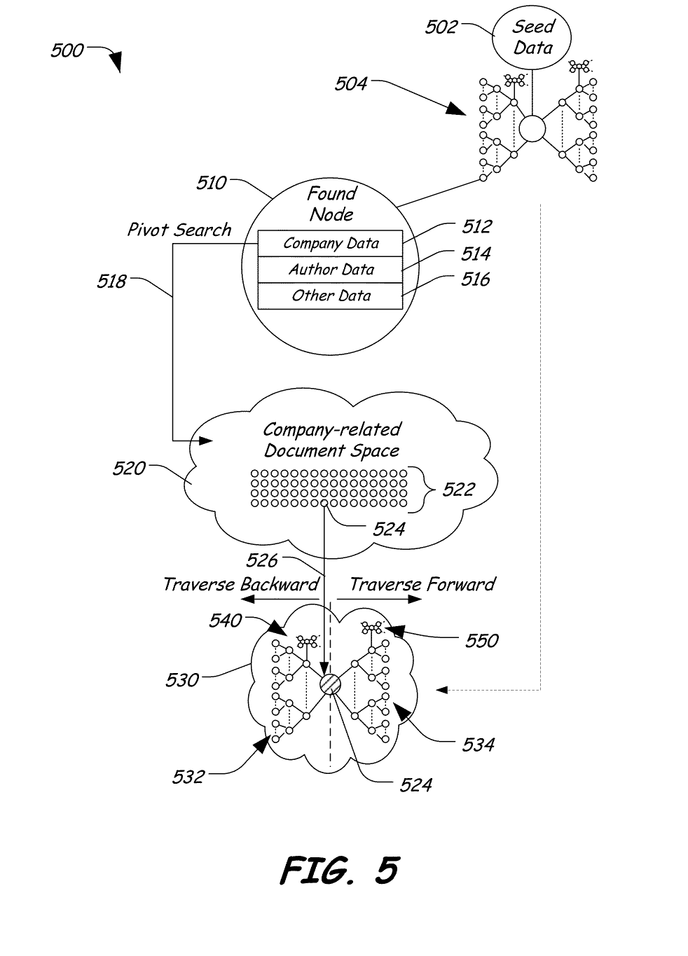

FIG. 5 is a block diagram of a particular illustrative embodiment of method 500 of generating a set of search results illustrating multi-variable searching and bi-directional traversal of associations between documents. The method 500 includes receiving seed data 502. The seed data 502 may be a document identifier, such as an unique serial number, a title, an author, another data input, or any combination thereof. The seed data 502 is used to generate a first set of search results 504 including forward and backward document nodes. Each of the document nodes represents a multivariate document (i.e., a document including multiple data values associated with multiple attributes). For example, a found node 510 includes company data 512, author data 514, and other data 516, such as a document title, document content, a document identifier, bibliographic data, other information, or any combination thereof.

Any of the multiple variables (i.e., company data 512, author data 514, or other data 516) can be used to perform a pivot search 518 to identify a set of documents 522 from a document-related document space 520. A particular node 524 may be used as a new seed node to search 526 a document space 530 to produce a new set of forward and backward document nodes 534 and 532, respectively. Particular nodes of the forward and backward document nodes 534 and 532 may include pivot nodes, such as the pivot nodes 540 and 550, which may be associated with found document nodes based on a selected document dimension. In a particular embodiment, the backward and forward document nodes 532 and 534 may be merged with the first set of search results 504 to produce a combined set of document results.

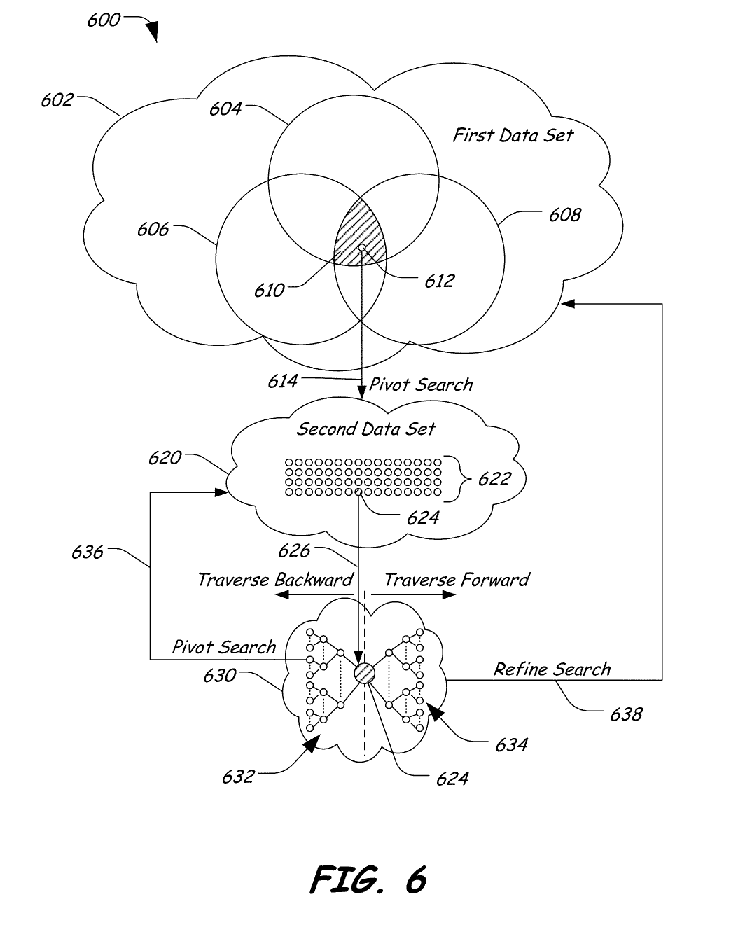

FIG. 6 is a block diagram of a fourth particular illustrative embodiment of a set of search results 600 illustrating multi-variable searching and bi-directional traversal of associations between documents. The set of search results 600 includes a first data set 602 that includes an intersection 610 of a first set of documents 604 having a first attribute, a second set of documents 606 having a second attribute, and a third set of documents 608 having a third attribute. The intersection 610 includes a first document 612, which has multiple attributes. A pivot search 614 can be performed using a selected one of the multiple attributes to generate a second data set 620 including a plurality of document nodes 622. A selected document node 624 includes multiple attributes. The selected document 624 can be provided as seed data 626 to produce a third set of documents 630 including a plurality of backward and forward related documents 632 and 634, respectively. Additionally, a pivot search 636 can be performed to produce a new data set, such as the second data set 620. Further, the third document set 630 can be further refined via a refine search function 638 to produce still another data set, and the process can be repeated.

In a particular embodiment, the traverse forward/traverse backward feature may be used in conjunction with keywords, date limiters, and other filters to produce a desired document set. Further, the traverse forward/traverse backward feature can be used to expand a document set to produce a broad set of search results, which the user can limit through filtering and refinement searches to locate particular documents.

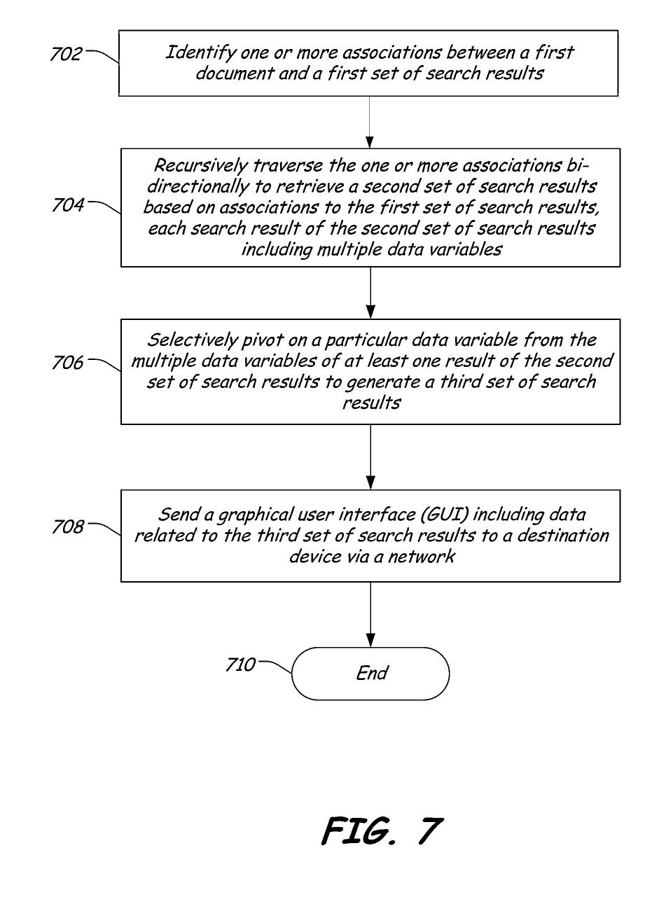

FIG. 7 is a flow diagram of a particular illustrative embodiment of a method of generating a set of search results. At 702, one or more associations are identified between a first document and a first set of search results. Moving to 704, the one or more associations are recursively traversed bi-directionally to retrieve a second set of search results based on associations to the first set of search results, where each search result of the second set of search results includes multiple data variables. In a particular embodiment, the one or more associations are recursively traversed bi-directionally by extracting one or more directed links and at least one attribute from the first document, traversing the one or more directed links to identify associated documents in a document space, and concurrently searching the document space to identify other documents that refer to the first document. The associated documents and the other documents represent the first set of search results. In a particular embodiment, the first set of search results are derived by iteratively extracting, traversing, and searching to expand the first set of search results.

Continuing to 706, a particular data variable from the multiple data variables of at least one result of the second set of search results is selectively pivoted on to generate a third set of search results. Advancing to 708, a graphical user interface (GUI) including data related to the third set of search results is sent to a destination device via a network. In a particular embodiment, the GUI includes a plurality of selectable indicators corresponding the third set of search results. The method terminates at 710.

In a particular embodiment, the third set of search results are filtered based on at least one criteria to produce a fourth set of search results, where the data related to the third set of search results includes the fourth set of search results. In a particular example, the GUI includes a plurality of selectable indicators related to the third set of search results. The method can further include receiving a user input related to a selected indicator from the plurality of selectable indicators and providing a second user interface to the user device including data related to a document corresponding to the selected indicator.

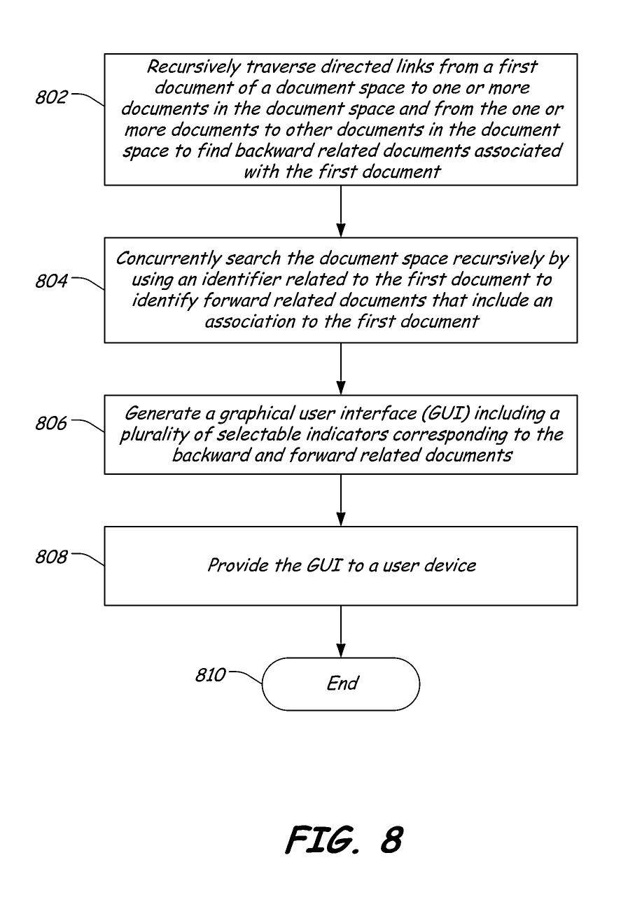

FIG. 8 is a flow diagram of a second particular illustrative embodiment of a method of generating a set of search results. At 802, directed links from a first document of a document space are recursively traversed to one or more documents in the document space and from the one or more documents to other documents in the document space to find backward related documents associated with the first document. In a particular embodiment, the directed links represent relationships between documents within the document space. In a particular example, the directed links include hypertext links, bibliographic citations, other document identifiers, or any combination thereof. Generally, each directed link corresponds to at least one document within the document space.

Moving to 804, the document space is concurrently searched recursively by using an identifier related to the first document to identify related documents that include an association to the first document and using identifiers from the related documents to identify forward related documents. In a particular embodiment, the document space is recursively searched concurrently with the recursive traversal of directed links. Advancing to 806, a graphical user interface (GUI) is generated that includes a plurality of selectable indicators corresponding to the backward and forward related documents. Continuing to 808, the GUI is provided to a destination device. The method terminates at 810.

In a particular embodiment, the method further includes receiving seed data from the destination device and retrieving the first document from the document space based on the received seed data. In another particular embodiment, the method includes identifying an attribute associated with a particular document from the backward and forward related documents, searching the document space using the identified attribute to produce a set of pivot search results corresponding to documents related to the identified attribute, and providing a second GUI including a second plurality of selectable indicators corresponding to the set of pivot search results.

In another particular embodiment, searching the document space using the identified attribute includes recursively traversing directed links from the set of pivot search results to identify backward related documents associated with the set of pivot search results and recursively searching the document space using identifiers related to the set of pivot results to identify related documents that include at least one association to the set of pivot search results. The identifiers from the related documents can be used to identify forward related documents.

In still another particular embodiment, recursively searching includes searching the document space using the identifier to retrieve a first plurality of documents related to the first document, parsing the first plurality of documents to determine a first plurality of identifiers, and recursively searching the document space using the first plurality of identifiers to retrieve a second plurality of documents related to the first plurality of documents. The method may also include providing a second GUI to the destination device, the second GUI, which includes user selectable indicators related to the second plurality of documents.

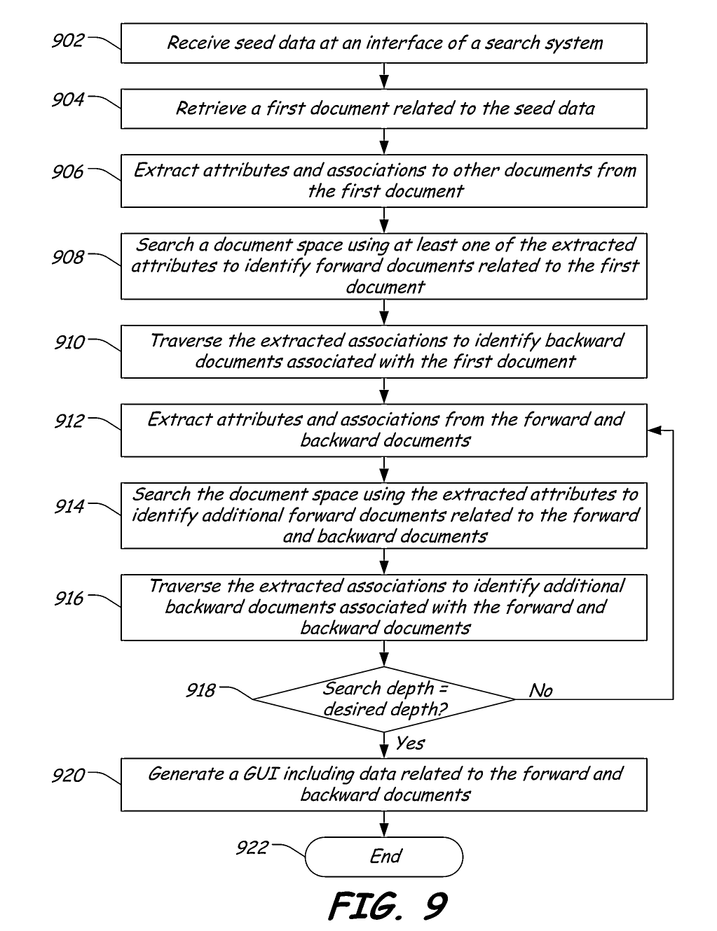

FIG. 9 is a flow diagram of a third particular illustrative embodiment of a method of generating a set of search results. At 902, seed data is received at an interface of a search system. Moving to 904, a first document is retrieved that is related to the seed data. Continuing to 906, attributes and associations to other documents are extracted from the first document. Advancing to 908, a document space is searched using at least one of the extracted attributes to identify forward documents related to the first document. Proceeding to 910, the extracted associations are traversed to identify backward documents associated with the first document. In a particular embodiment, the extracted associations are directed links, such as hypertext links or citation data that specifically identifies a particular document. The search and the association traversal processes can be performed concurrently or substantially simultaneously.

Continuing to 912, attributes and associations are extracted from the forward and backward documents. Moving to 914, the document space is searched using the extracted attributes to identify additional forward documents related to the forward and backward documents. Advancing to 916, the extracted associations are traversed to identify additional backward documents associated with the forward and backward documents. In a particular example, searching extracted attributes and traversing extracted associations are performed substantially concurrently.

At 918, if a search depth has not reached a desired search depth (i.e., if a number of iterations is less than a desired number of iterations), the method returns to 912 and the attributes and associations are extracted from the forward and backward documents. Otherwise, if a desired search depth is reached at 918, the method advances to 920 and a graphical user interface (GUI) is generated that includes data related to the forward and backward documents. In a particular embodiment, the data may include a user selectable list of the search results. In another particular embodiment, the data may include a graphical representation of the forward and backward documents. For example, the forward and backward documents represent a set of search results, and the set of search results can be displayed as a industry map, a company chart, a list of search results, a plot map, other graphical visualizations, or any combination thereof. The method terminates at 922.

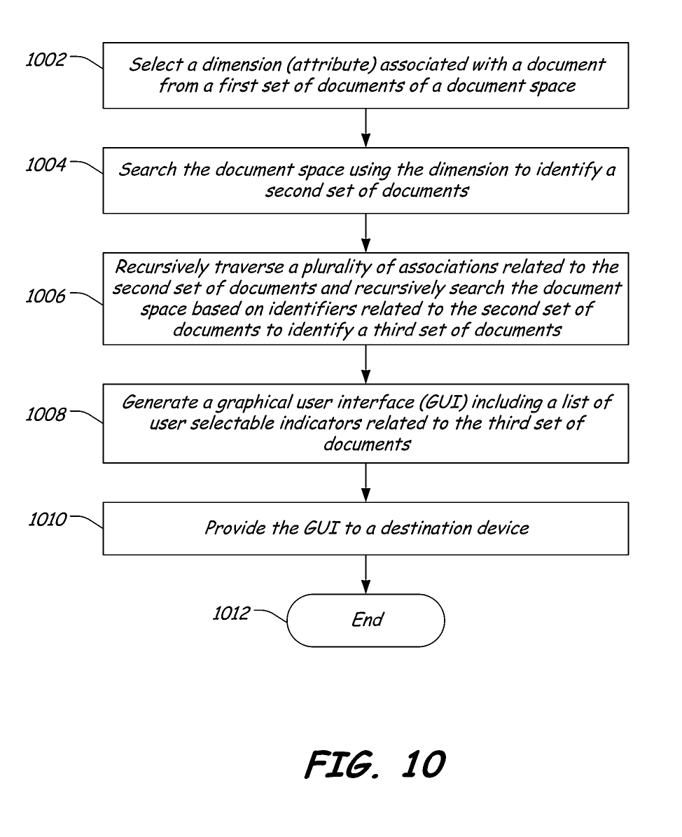

FIG. 10 is a flow diagram of a fourth particular illustrative embodiment of a method of generating a set of search results. At 1002, a dimension (attribute) associated with a document is selected from a first set of documents of a document space. Moving to 1004, the document space is searched using the dimension (attribute) to identify a second set of documents. Continuing to 1006, a plurality of associations related to the second set of documents is recursively traversed and the document space is recursively searched based on identifiers related to the second set of documents to identify a third set of documents. Advancing to 1008, a graphical user interface (GUI) is generated that includes a list of user selectable indicators related to the third set of documents. In a particular embodiment, the GUI includes a visualization that is related to the third set of documents. The visualization can be a document landscape, a company visualization, a visualization of financial data associated with companies that are included in the search results, other visualizations, or any combination thereof. Proceeding to 1010, the GUI is provided to a destination device. The method terminates at 1012.

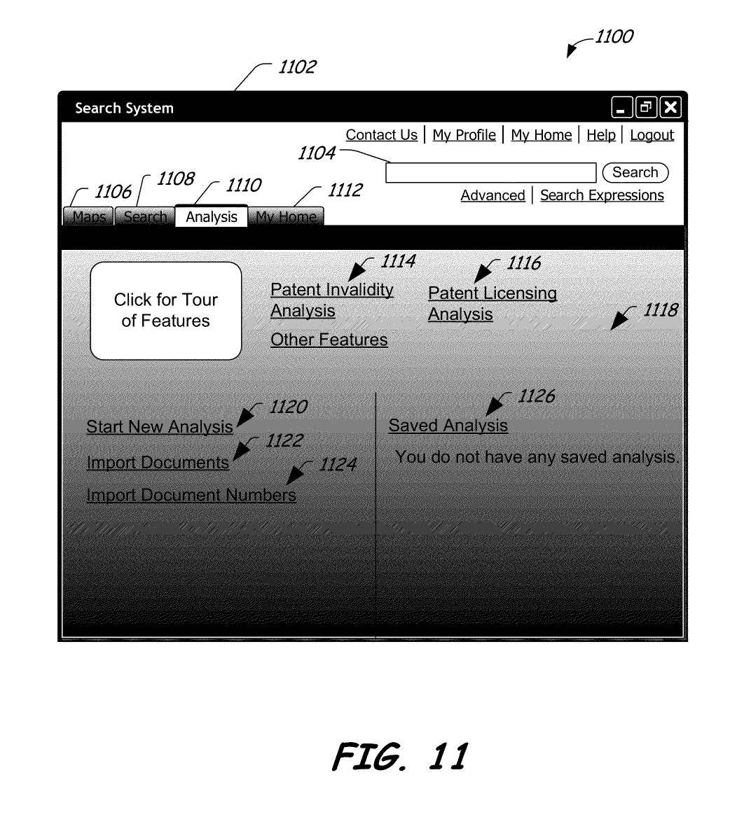

FIG. 11 is a diagram of a particular illustrative embodiment of a graphical user interface (GUI) 1100 to generate a set of search results using structured or unstructured searches. The graphical user interface 1100 is adapted to interact with a back-end system that includes one or more data sources. In a particular example, one of the data sources may be a patent database. In particular, the graphical user interface 1100 includes a window 1102 that has a text search input 1204 and multiple user selectable indicators, including a “Maps” tab 1106, a “Search” tab 1108, an “Analysis” tab 1110, and a “My Home” tab 1112. In a particular embodiment, the “Maps” tab 1106 is a user selectable indicator that is accessible to a user to select and view visualizations of a set of search results. The “Search” tab 1108 is a selectable indicator that is accessible to a user to initiate a search of a document space. The “Analysis” tab 1110 is a selectable indicator that is accessible to a user to access various search features, such as goal-oriented searches via an “Analysis” panel 1118. The “Analysis” panel 1118 includes a “Patent Invalidity Analysis” selectable indicator 1114, which may be utilized to perform a one-click goal-oriented search to identify a list of potentially invalidating prior art for a particular patent. The “Analysis” panel 1118 also includes a “Patent Licensing” selectable indicator 1116, which may be accessed to perform a one-click goal oriented search to identify a list of likely infringers of a particular patent. Additionally, the “Analysis” panel 1118 may include a user selectable indicator to access one or more stored (“saved”) analyses via a “Saved Analysis” link 1126, as well as selectable options to start a new analysis (“Start New Analysis” link 1120), to import documents (“Import Documents” link 1112), and to import document numbers (“Import Document Numbers” link 1114).

In a particular illustrative embodiment, in response to receiving data related to a selection of the “Patent Invalidity Analysis” selectable indicator 1114, the graphical user interface 1100 may display a popup window to receive a patent number (i.e., seed data) of a patent to invalidate. The patent number may be submitted to the search system, which retrieves the patent from the United States Patent and Trademark Office website, analyzes references cited within the retrieved patent, searches the cited references and references cited within those cited references, and surfaces a list of search results of prior art that was not cited in the patent to invalidate. Additionally, the search system may apply additional logic to extract key terms and to retrieve search results from international search classifications associated with the patent to invalidate, either based on the document itself, based on classification data (such as the North American Industry Classification system), or any combination thereof. The search system may also search for documents that referenced the particular patent and analyze documents cited by those patents or patent publications. Additionally, the search system may provide the search results to the graphical user interface for display to the user. Additionally, the user may search within the search results by entering keywords to refine the search. The results of the search may be provided within the GUI 1100.

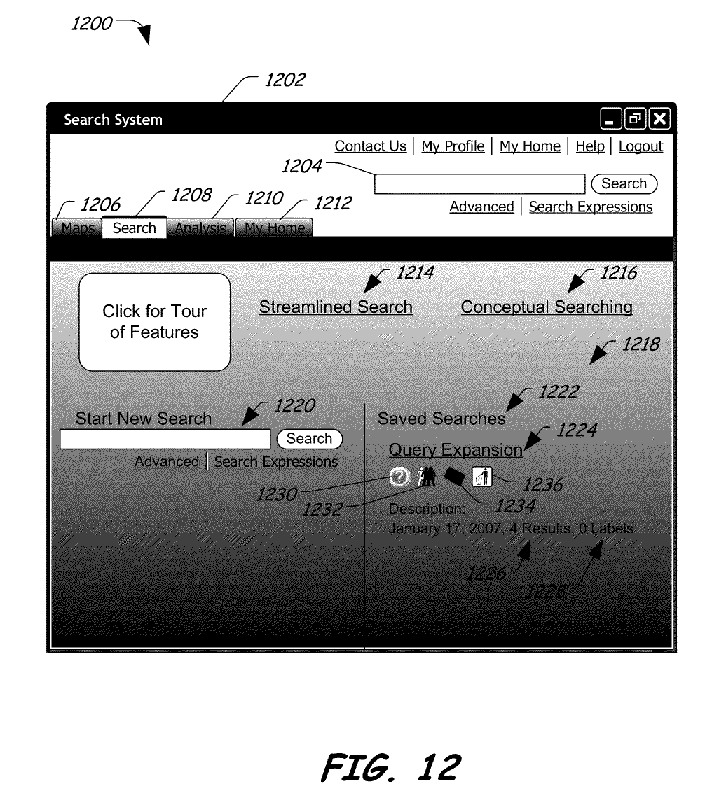

FIG. 12 is a diagram of a second particular illustrative embodiment of a graphical user interface (GUI) 1200 to generate a set of search results using unstructured or partially structured searches. The user interface 1200 includes a window 1202, including a text search input 1204 and user selectable tabs, including a “Maps” tab 1206, a “Search” tab 1208, an “Analysis” tab 1210, and a “My Home” tab 1212. In this instance, the “Search” tab 1208 is selected, such that a search panel 1218 is displayed. The search panel 1218 includes selectable options, including a “Streamlined Search” option 1214 and a “Conceptual Searching” option 1216. The “Streamlined Searching” option 1214 provides a targeted search scope to allow a user to search particular terms within a particular database. The “Conceptual Search” option 1216 provides a broad search opportunity to identify all of the documents and not just the particular results. In other words, the graphical user interface 1200 provides a means by which a user can restrict or adjust search results to have high precision and/or high recall. The search panel also includes an option to start a new search 1220 and can include a list of saved searches 1222. In a particular illustrative embodiment, the list of saved searches 1222 includes a query expansion search snapshot 1224, which can be presented as a selectable link. Further, the “Search” panel 1218 includes statistics related to the saved “Query Expansion” search snapshot 1224, including a number of results 1226 and a number of labels 1228 associated with the number of results. In particular, the GUI 1200 may include an option to attach a label or descriptor to one or more of the search results. Additionally, the query expansion search snapshot 1224 is associated with the user selectable icons including an information icon 1230 to access information about the search or about the GUI 1200, a sharing icon 1232 to share a saved search, an e-mail icon 1234 to email results of a search to another user, and a trash icon 1236 to delete a saved search.

In general, a user may select one or more of the selectable indicators to interact with the graphical user interface 1200. For example, the user may click the info icon 1230 to change the name or otherwise alter information related to the stored search history. The user may share the search with other users by clicking on the share icon 1232. The user may e-mail the search results to another user by clicking on the e-mail icon 1234, or the user may delete the search by clicking on the delete icon 1236. Additionally, the user may access other aspects of the search system by clicking on one or more of the selectable indicators. Additionally, a description of the “Query Expansion” search snapshot 1224 includes a date of the particular search snapshot, a first indicator 1226 of a number of results in the search and a second indicator 1228 of a number of labels. In a particular illustrative example, a user may interact with the graphical user interface 1200 to rate individual search results on a scale from irrelevant to relevant (e.g., from one star to five stars). By rating a particular search result, the user can label selected results.

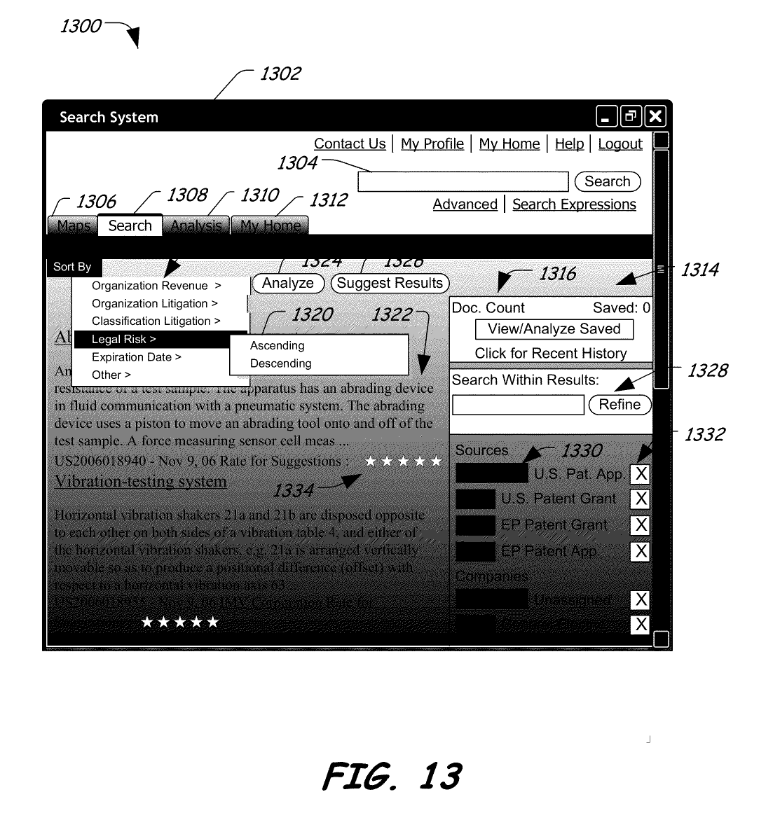

FIG. 13 is a diagram of a particular illustrative embodiment of a graphical user interface (GUI) 1300 including user selectable indicators related to a list of search results. The graphical user interface 1300 includes a window 1302. The window 1302 includes a search text input 1304 and multiple user selectable tabs, including a Maps” tab 1306, a “Search” tab 1308, an “Analysis” tab 1310, and a “My Home” tab 1312. In this particular instance, the “Search” tab 1308 is selected to display a search panel 1314. The search panel 1314 includes a drop-down menu 1318 and a control panel 1316. Further, the search panel 1314 includes a list of search results 1322. Each search result of the list of search results 1322 is associated with selectable indicators, such as the selectable indicators 1334 for rating the search result on a scale of one to five stars (i.e. from “not relevant” to “relevant”). The selectable indicators 1334 are illustrative of one possible rating system. In a particular illustrative embodiment, the selectable indicators 1334 may be check boxes, radio buttons, other selectable objects, or any combination thereof. In another particular illustrative embodiment, the selectable indicators 1334 may be replaced with a numeric text input, a sliding bar (an adjustable element), another input type, or any combination thereof. The selectable indicators 1334 allow the user to provide explicit feedback to the search system, which can use the explicit feedback to train a query learner and a document learner and to reverse engineer the search to produce new queries.

In a particular illustrative embodiment, the contents of the control panel 1316 are dynamically generated by the search system based on the list of search results 1322. The control panel 1316 includes statistical information, such as a bar 1330 that represents a relative number of documents associated with a particular category from the search results, e.g., “United States Patent Applications.” Additionally, each category may include a selectable option 1332, which a user may select to filter out search results that correspond to a particular category.

In a particular illustrative example, if a user selects the selectable option 1332 that is associated with the category “U.S. Pat. App.,” the list of search results 1322 would be adjusted to remove patent applications from the displayed list. The selectable option 1332 may be called a “negation” option. Each category associated with the search results may be separately filtered, such that the user can selectively filter out “unassigned” patents and applications, particular companies, particular types of documents, other categories, or any combination thereof. In a particular illustrative embodiment, other document sources may include commercial databases, governmental databases, other data sources, or any combination thereof, which may be filtered using the selectable options 1332 that correspond with the particular category identifying the respective data source. Other categories of the search results may include industry classifications, geographic information, date information, other information, or any combination thereof.

Referring again to FIG. 13, the graphical user interface 1300 can include a “SORT BY” menu option 1318 that can be accessed by a user to sort items within the list of search results 1322. Each item within the list of search results 1322 may be related to a particular document. The SORT BY menu option 1318 allows the user to sort the items based on information that may or may not be contained within the documents. The “SORT BY” menu option 1318 includes an “Organization Revenue” option, an “Organization Litigation” option, a “Classification Litigation” option, an “Expiration Date” option, an “Other” option, and a “Legal Risk” option. The Organization Revenue option allows the user to sort the search results based on revenues of companies that own the document (e.g., assignees of the patent documents). The Organization Litigation option can be accessed to sort the search results based on a litigation history of an organization that owns the document. The Classification Litigation can be accessed to sort the search results based on a litigation history of the classification of the document. For example, a level of litigation activity within a particular classification with which the document is associated (e.g., semiconductor devices). The Expiration Date option can be accessed to sort the search results from a Patent Office (e.g., the United States Patent Office, the European Patent Office, other patent offices, or any combination thereof) based on a calculated expiration date, failure to pay maintenance fees, or invalidation. The search system can also calculate expiration dates for other types of data, such as Small Business Administration Innovative Research grants, which may have a request for proposal expiration date. Further, the search system can determine expiration dates related to Copyrights, Trademarks, user-defined expiration dates (such as an email expiration date), other expiration dates, or any combination thereof.

Other sorting options may include a number of documents associated with an organization or classification, a relevance ratings, date data, financial data, location data, author data, statistical data, reference data, pricing data, credit history, enterprise data, employee data, litigation data, user-provided data, user-defined sorting algorithm, or any combination thereof.

The Legal Risk option can be accessed by a user to sort the search results based on a probabilistic determination of legal risk (e.g., likelihood of a lawsuit, likelihood of a citation by another document, likelihood of licensing opportunities, other factors, or any combination thereof). In a particular illustrative, non-limiting embodiment, the search system can evaluate the legal risk based on patents and patent publications. In such an instance, the legal risk can be based on a number of claims, a number prior art citations, a number of forward references (e.g., references that cite the particular patent), a length of time between filing and grant of the patent, number of figures, number of pages, age of patent, number of inventors and information associated with the inventor (number of patents listing the inventor, distribution of patents within classification system, employment records, number of citations from other patents, number of publications or work outside of patents, other data, or any combination thereof).

Additionally, in such an instance, the legal risk can be based on assignee data, such as litigation history, financial history, entity type (e.g. university, small business, non-profit organization, inventor), local or foreign location, number of patents, number of citations from other publications, number of publications outside of patents, associations with industry standards, number of products, number of inventors, number of employees, other data, or any combination thereof. Also, in such an instance, the legal risk can be based on assignee data or the absence thereof. Further, the legal risk can be based on classification data, including litigation history, number of patents, number of citations, number of inventors, other data, or any combination thereof, within a particular classification. Additionally, the legal risk can be based on location data, including geographic data, logic geographic groupings (such as legal jurisdictions), litigation history data, country-based data (e.g., international laws, country-specific laws, treaties, other groupings, or any combination thereof), financial information, proximity to universities (i.e. proximity to intellectual talent pool), other categories, or any combination thereof. Additionally, the legal risk can be related to user-provided data or user-assigned rankings. In a particular embodiment, any of the above-listed factors may be used in any combination to evaluate legal risk.

In a particular instance, the Legal Risk option can be selected to access an associated submenu 1320, from which the user may specify an ascending or a descending order for the sorted results. Depending on which menu option is selected from the SORT BY menu 1318, other submenus and related sorting options can be accessed, allowing a user to view the same data in a variety of different ways.

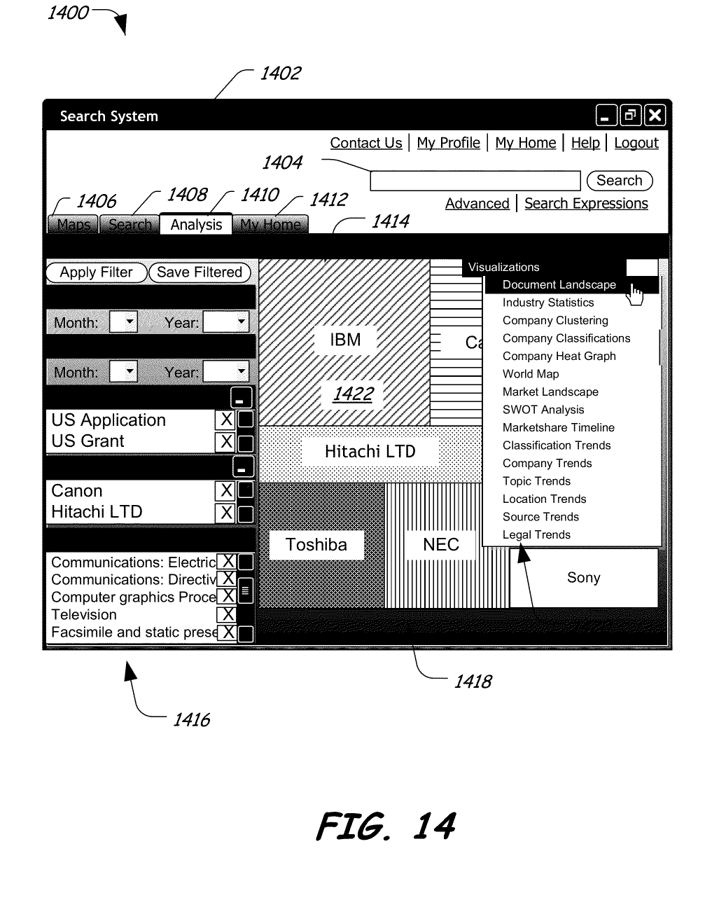

FIG. 14 is a diagram of a second particular illustrative embodiment of a graphical user interface (GUI) 1400 including a visualization of the set of search results. The graphical user interface 1400 includes a window 1402, which has a search text input 1404 and multiple user selectable indicators, including a “Maps” tab 1406, a “Search” tab 1408, an “Analysis” tab 1410, and a “My Home” tab 1412. The window 1402 further includes a visualization panel 1414 to display multiple visualizations of a particular set of search results, such as a document landscape map 1418, and includes a control panel 1416. The document landscape map 1418 includes multiple selectable graphical elements, such as the selectable graphical element 1422 to access documents associated with a particular classification or category of the search results. The graphical user interface 1400 also includes a menu of selectable options 1420 for selecting between visualizations. The available visualizations that can be accessed using the menu of selectable options 1420 can include a document landscape visualization, an industry statistics visualization, a company clustering visualization, a company classifications visualization, a company “heat graph” visualization, a world map visualization, a market landscape visualization, a “strengths-weaknesses-opportunities-threats” (SWOT) visualization, a market-share timeline visualization, a classification trends visualization, a company trends visualization, a topic trends visualization, a location trends visualization, a source trends visualization, and a legal trends visualization. Visualizations may be added or omitted, depending on the particular implementation.

In a particular illustrative embodiment, each of the multiple selectable graphic elements, including the selectable graphic element 1422, has a size dimension indicating a relative number of documents associated with the particular category of information. Each of the selectable graphic elements may also have a respective color dimension, shading dimension, hatching dimension, or other visual indicator that represents the relative number of documents.

In a particular illustrative embodiment, the control panel 1416 provides multiple selectable options, including selectable classification negation options, selectable date options and other options. Selection of one of the selectable classification negation options causes the graphical user interface 1400 to display a document landscape 1418 that is adjusted according to the selection.

In general, while the above-discussion has described a particular implementation of a search system including a forward/backward traversal feature, it should be understood that the bi-directional traversal of associations between found documents (i.e., data elements) may be implemented in any number of search systems. Further, it should be understood that, since the forward/backward traversal feature is adapted to utilize an attribute to identify forward documents, the search feature can be used to generate a set of search results even within a document space including unstructured data.

Additionally, one particular advantage provided by embodiments of a search system including the forward/backward traversal feature is that a depth and breadth of a search related to a particular document is both targeted to particular subject matter (via the associations) and broad because it retrieves forward and backward documents that may utilize different terminology.

Although the present invention has been described with reference to preferred embodiments, workers skilled in the art will recognize that changes may be made in form and detail without departing from the spirit and scope of the invention.

What is claimed is:

1. A system comprising:
a processor; and
a memory accessible to the processor and storing instructions that, when executed, cause the processor to:
identify backward citations and forward citations associated with each search result of a set of search results corresponding to a seed data input, each backward citation including a bibliographic reference in the search result that identifies a document, each forward citation including a bibliographic reference within a document that identifies the search result;
retrieve documents corresponding to the forward citations and the backward citations from one or more data sources;
iteratively identify the backward citations and the forward citations in the retrieved documents and retrieve more documents corresponding to the backward citations and the forward citations for each document and for three or more iterations to produce a set of search results;
selectively filter the set of search results according to the seed data input to produce filtered search results; and
generate a graphical user interface (GUI) including at least a portion of the filtered search results.

2. The system of claim 1, wherein the memory further stores instructions that, when executed, cause the processor to:
extract an attribute from the set of search results;
search at least one data source based on the attribute to retrieve ancillary data; and
join the ancillary data to the set of search results prior to selectively filtering the set of search results.

3. The system of claim 2, wherein the filtered search results and associated ancillary data are included within the GUI.

4. The system of claim 1, further comprising:
a network interface coupled to the processor and configured to communicate with one or more devices through a network; and
wherein the memory further stores instructions that cause the processor to provide the GUI to a device through the network.

5. The system of claim 1, wherein the memory further stores instructions that, when executed, cause the processor to:
extract a plurality of attributes from the set of search results; and
selectively pivot on at least one of the plurality of attributes to search at least one data source using the extracted attribute to determine a set of pivot search results.

6. The system of claim 1, wherein at least one of the backward citations and the forward citations comprises a directed link including a hypertext link to a document.

7. The system of claim 1, wherein at least one of the backward citations and the forward citations includes a bibliographic citation to a non-patent literature reference.

8. The system of claim 1, wherein the seed data input includes a document identifier and a pre-defined type of analysis.

9. The system of claim 8, wherein the pre-defined type of analysis includes a patent invalidity analysis.

10. The system of claim 9, wherein the processor selectively filters the set of search results by removing documents that have a priority date that is later than a priority date associated with a patent corresponding to the document identifier.

11. A method comprising:
receiving a seed data input at a search system;
automatically retrieving a document using the search system in response to the seed data;
iteratively searching a document space based on backward citations within the document and within documents corresponding to the backward citations to produce backward citation documents;
iteratively searching the document space based on forward citations corresponding to an attribute of the document and of documents corresponding to the forward citations to produce forward citation documents;
selectively filtering the backward citation documents and the forward citation documents based on the seed data input to produce filtered search results; and
generating a graphical user interface (GUI) including at least a portion of the filtered search results.

12. The method of claim 11, further comprising:
extracting an attribute from the set of search results;
searching at least one data source based on the attribute to retrieve ancillary data associated with at least one result of the set of search results; and
joining the ancillary data to the set of search results prior to selectively filtering the set of search results.

13. The method of claim 12, wherein generating the GUI includes providing at least a portion of the filtered search results and the ancillary data.

14. The method of claim 11, further comprising:
extracting a plurality of attributes from the set of search results; and
selectively pivoting on at least one of the plurality of attributes to search at least one data source using the extracted attribute to determine a set of pivot search results.

15. The method of claim 11, wherein at least one of the backward citations and the forward citations comprises a directed link including a hypertext link to a document.

16. The method of claim 11, wherein at least one of the backward citations and the forward citations includes a bibliographic citation to a non-patent literature reference.

17. The method of claim 11, wherein selectively filtering the backward citation documents and the forward citation documents comprises removing the backward citation documents and the forward citation documents that have a priority date that is later than a priority date associated with a patent corresponding to a document identifier of the seed data input.

18. A system comprising:
a processor; and
a memory accessible to the processor and storing instructions that, when executed, cause the processor to:
perform a search operation on a document space based on a seed data input including a document identifier and a selection of a type of analysis, the search operation including retrieving documents based on backward citations and forward citations from the document associated with the document identifier and iteratively retrieving forward citations and backward citations from the documents to produce a set of search results through three or more iterations;
selectively filter the set of search results according to the type of analysis to produce filtered search results; and
generate a graphical user interface (GUI) including at least a portion of the filtered search results.

19. The system of claim 18, wherein the type of analysis comprises a patent invalidity analysis and wherein the processor selectively filters the set of search results by removing documents having a priority date after a priority data of the document associated with the document identifier.

20. The system of claim 18, wherein the memory further includes instructions that, when executed, cause the processor to:
extract an attribute from the set of search results;
search at least one data source based on the attribute to retrieve ancillary data associated with at least one result of the set of search results; and
join the ancillary data to the set of search results prior to selectively filtering the set of search results.
